(19) United States
(12) Patent Application Publication
(10) Pub. No.: US 2015/0288231 A1
(43) Pub. Date: Oct. 8, 2015

(54) ELECTRIC MOTOR WITH SYMMETRIC COOLING

(71) Applicant: SOLAR TURBINES INCORPORATED, San Diego, CA (US)

(72) Inventors: David B. Jahnz, San Diego, CA (US); Jason Wing-Bin Fong, San Diego, CA (US); Lei Zhu, San Diego, CA (US)

(73) Assignee: SOLAR TURBINES INCORPORATED, San Diego, CA (US)

(21) Appl. No.: 14/468,246

(22) Filed: Aug. 25, 2014

Related U.S. Application Data
(60) Provisional application No. 61/975,498, filed on Apr. 4, 2014.

(51) Int. Cl. H02K 1/20

(52) U.S. Cl. CPC H02K 1/20

(57) ABSTRACT

An electric motor for a rotary machine is disclosed. The electric motor includes a first lamination section and a second lamination section radially spaced apart from a driver shaft forming a first air gap and a second air gap respectively. The second lamination section is axially spaced apart from the first lamination section forming an air gap cooling outlet there between. The electric motor also includes motor windings extending through the first lamination section and the second lamination section, and across the air gap cooling outlet in circumferential groups. A winding shield is located around each of the circumferential groups of the motor windings.

### CROSS-REFERENCE TO RELATED APPLICATIONS

The application claims the benefit of U.S. provisional patent application Ser. No. 61/975,498, filed Apr. 4, 2014, which is hereby incorporated by reference.

### TECHNICAL FIELD

The present disclosure generally pertains to rotary machines, and toward a gas compressor with an integrated electric motor with symmetric cooling.

### BACKGROUND

Electric motors convert electrical energy to mechanical energy to drive rotary machines, such as centrifugal gas compressors. The electric motor and the rotary machine can be assembled into a single housing. This integrated system may be more compact than a separate electric motor and rotary machine system. Various components of the electric motor and the rotary machine system may require cooling during operation of the system(s).

U.S. Pat. No. 7,462,962 issued to De Bock et al. on Dec. 9, 2008 discloses an electrical machine including a stator having a radially inwardly directed duct adjacent the center of the machine for flowing cooling medium into the gap between the stator and rotor. The rotor includes radial or diagonal ducts having scoops for directing flow generally radially inwardly to cool the field windings in the center of the machine. The cooling medium flows either into subslots for radial or diagonal outward flow through outlet ducts for return to the gap.

The present disclosure is directed toward overcoming one or more problems discovered by the inventors or that is known in the art.

### SUMMARY OF THE DISCLOSURE

An electric motor for a rotary machine is disclosed. In one embodiment, the electric motor includes a motor can, a driver shaft, end windings, a lamination sleeve, stator laminations, motor windings, and a plurality of winding shields. The motor can includes a body, motor cooling inlets extending through the body adjacent opposite ends of the body, and motor cooling outlets extending through the body. The driver shaft extends through the motor can. End windings are within the motor can located at each of the opposite ends of the motor can and about the driver shaft. The lamination sleeve is centrally located within the motor can. The lamination sleeve includes a hollow cylinder shape and lamination sleeve cooling outlets extending through the hollow cylinder shape. The lamination sleeve cooling outlets align with the motor cooling outlets. Stator laminations are located within the lamination sleeve. The stator laminations include a first lamination section radially spaced apart from the driver shaft forming a first air gap, and a second lamination section radially spaced apart from the driver shaft forming a second air gap. The second lamination section is axially spaced apart from the first lamination section forming an air gap cooling outlet there between. The air gap cooling outlet being in flow communication with the first air gap, the second air gap, and the lamination sleeve cooling outlets. Motor windings extend through the stator laminations and across the air gap cooling outlet. The motor windings are arranged in circumferential groups across the air gap cooling outlet forming circumferential gaps there between. Each winding shield is located around one of the circumferential groups of the motor windings.

### BRIEF DESCRIPTION OF THE DRAWINGS

FIG. 1 is a perspective view of an exemplary gas compressor integrated machine.

FIG. 2 is a cross-sectional view of the integrated machine of FIG. 1.

FIG. 3 is a detailed view of the cross-section of FIG. 2 at the motor section.

FIG. 4 is a cross-sectional view of the integrated machine of FIG. 2 taken along the line IV-IV.

FIG. 5 is a detailed view of the cross-section of FIG. 4.

FIG. 6 is a perspective view of a winding shield of FIGS. 3-5.

FIG. 7 is a detailed view of the cross-section of FIG. 2 at the rotary machine section.

### DETAILED DESCRIPTION

The systems and methods disclosed herein include an integrated machine including an electric motor and a rotary machine within a common housing. In embodiments, the electric motor and its components are located within a motor can fixed within the housing. Stator lamination sections are spaced apart forming an air gap cooling outlet. Motor windings extend through the stator lamination sections and across air gap cooling outlet. The motor windings are grouped together in a radial pattern about the driver shaft with cooling outlet gaps there between. Each group of motor windings includes a covering, such as fish paper around the group. Winding shields are placed over the covering of each group. The winding shields may act as a heat shield to protect the motor windings from a heated coolant/process gas that is exiting between the stator lamination sections, and may protect the motor windings from erosion/damage due to the heated coolant/process gas.

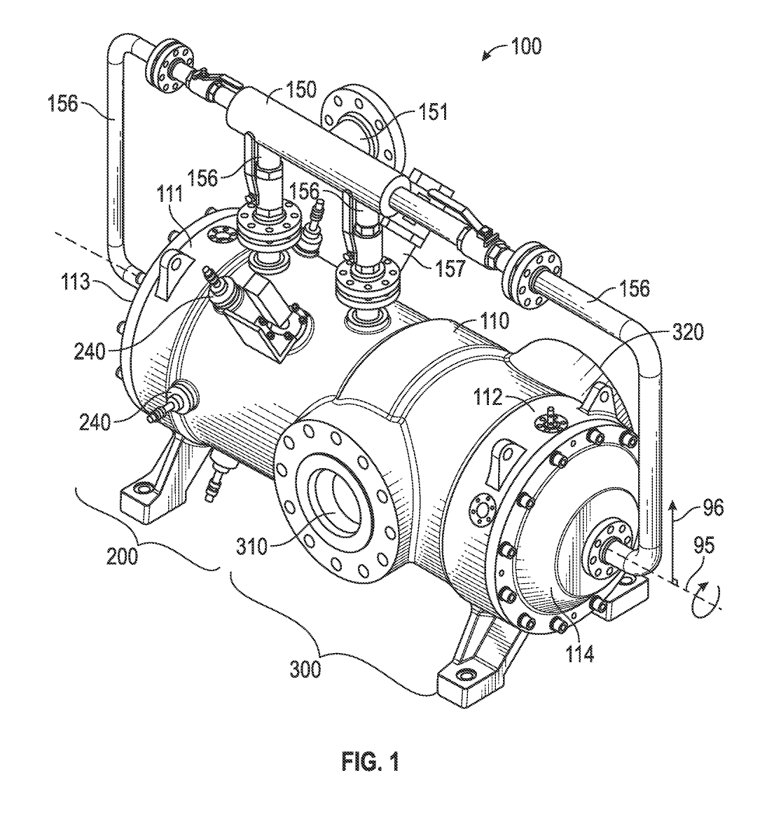

FIG. 1 is a perspective view of an exemplary integrated machine 100. In the example depicted, the integrated machine 100 is a gas compressor. Some of the surfaces may have been left out or exaggerated (here and in other figures) for clarity and ease of explanation. Also, the disclosure may reference a forward and an aft direction. Generally, all references to “forward” and “aft” are associated with a flow direction of a gas within the integrated machine 100. In the embodiment illustrated, the first end 111 is the forward end and the second end 112 is the aft end.

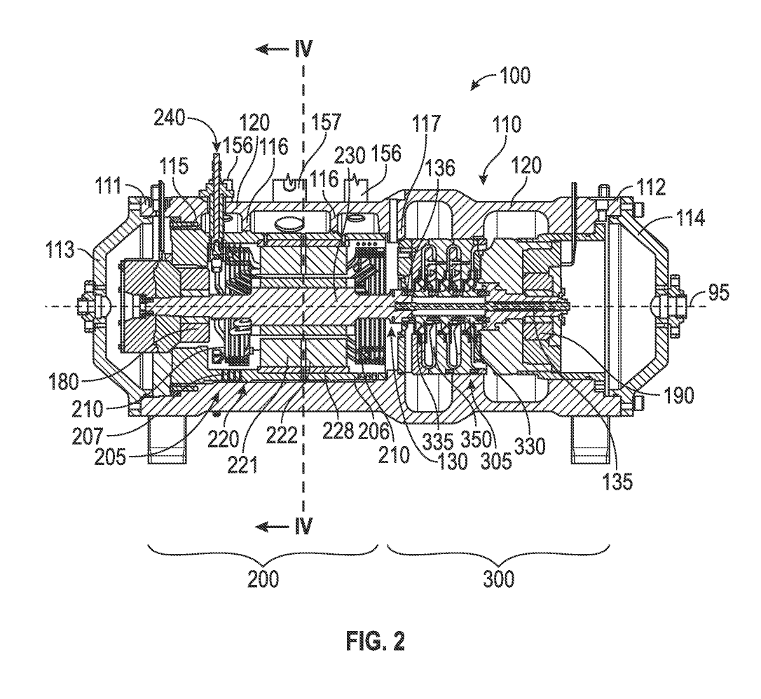

In addition, the disclosure may generally reference a center axis 95 of rotation of the rotary machine, which may be generally defined by the longitudinal axis of the rotor assembly 130 (shown in FIG. 2) of the integrated machine. The center axis 95 may be common to or shared with various other concentric components of the integrated machine 100, such as housing 110 and motor can 205. All references to radial, axial, and circumferential directions and measures refer to center axis 95, unless specified otherwise, and terms such as “inner” and “outer” generally indicate a lesser or greater radial distance from the center axis 95, wherein a radial 96 may be in any direction perpendicular and radiating outward from center axis 95.

The integrated machine 100 includes a housing 110, a motor section 200, and a rotary machine section 300. The housing 110 may include an outer shell 120 with a first end 111 and a second end 112, and multiple internal ridges. In the embodiment illustrated, the motor section 200 is adjacent the first end 111 and the rotary machine section 300 is adjacent the second end 112. The motor section 200 includes one or more power connectors 240 extending through the housing 110 to supply power to a motor assembly 205 (shown in FIG. 2). The rotary machine section 300 includes a rotary machine 305 (shown in FIG. 2). In the embodiment illustrated, the rotary machine 305 is a centrifugal gas compressor. As illustrated, the machine section 300 includes a suction port 310 adjacent the motor section 200 and a discharge port 320 adjacent the second end 112, aft of the suction port 310. In other embodiments, the flow may be in the opposite direction with the suction port 310 being adjacent the second end 112 and the discharge port 320 being adjacent the motor section 200. The integrated machine 100 may also include a first end cap 113 connected to the first end 111 of the housing 110 and a second end cap 114 connected to the second end 112 of the housing 110.

The integrated machine 100 may include coolant supply lines 150 for supplying a coolant, such as air to the integrated machine 100. The coolant supply lines 150 include a supply connection 151 that is configured to connect to a coolant supply. In the embodiment shown, coolant inlet lines 156 connect to each end cap of the integrated machine 100 and two coolant inlet lines 156 connect to the housing 110 at the motor section 200. In the embodiment illustrated, a coolant outlet line 157 also connects to the housing 110 at the motor section 200. The coolant supply lines 150 may include various flanges, fittings, and valves for connecting to the coolant supply and for controlling the flow of the coolant.

FIG. 2 is a cross-sectional view of the integrated machine 100 of FIG. 1. The rotor assembly 130 may include a driver shaft 230 located within the motor section 200 joined to a machine rotor 330 located within the rotary machine section 300. The driver shaft 230 may include shaft laminations 232. Shaft laminations 232 may be located on a radially outer portion of the driver shaft 230. In the embodiment illustrated, driver shaft 230 and machine rotor 330 are joined by a tierod 135 and may not need a coupling. Driver shaft 230 and machine rotor 330 may also be joined by bolts 136, or by other coupling means. The rotor assembly 130 is supported by a first bearing 180 and a second bearing 190. The first bearing 180 is located within the motor section 200 adjacent the first end 111 and is configured to support the end of the driver shaft 230 adjacent the first end 111. The second bearing 190 is located within the rotary machine section 300 adjacent the second end 112 and is configured to support the end of the machine rotor 330 adjacent the second end 112. The first bearing 180 and the second bearing 190 are radial bearings. The integrated machine 100 may also include a third radial bearing located between the first bearing 180 and the second bearing 190. The integrated machine 100 may further include a thrust bearing. In the embodiment illustrated, the bearings, including the first bearing 180 and the second bearing 190, are magnetic bearings. Other bearings, such as radial contact bearings, may also be used.

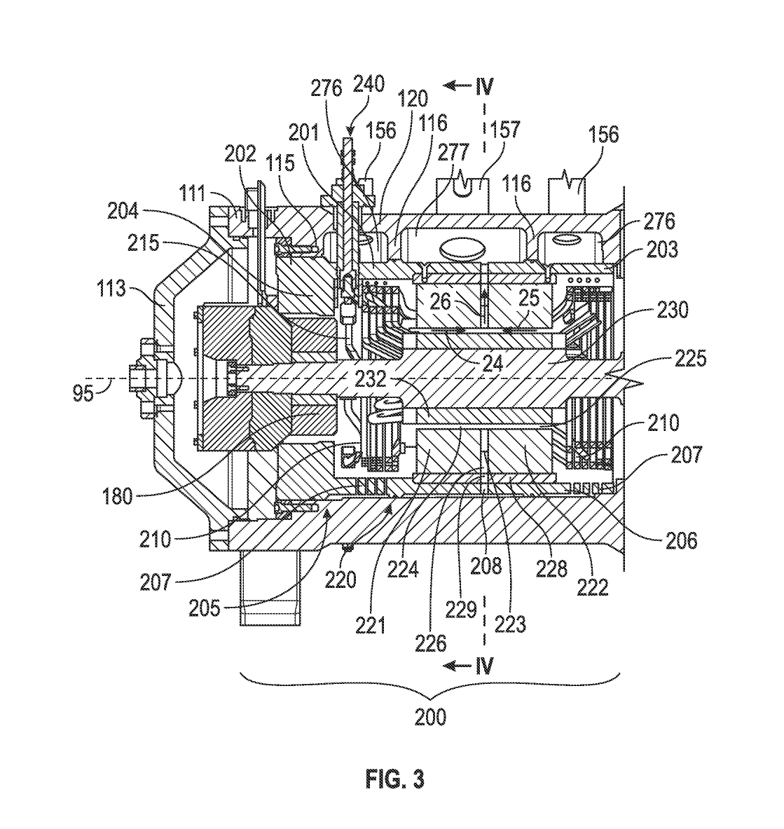

FIG. 3 is a detailed view of the cross-section of FIG. 2 at the motor section 200. Referring to FIGS. 2 and 3, the motor section 200 includes a motor assembly 205, coolant inlet passages 276, and coolant outlet passages 277. The motor assembly 205 includes a motor can 205, end windings 210, a lamination sleeve 228, stator laminations 220, and motor windings 223. Some of the motor assembly components, such as the end windings 210, the stator laminations 220, and motor windings 223 may be assembled within the motor can 205.

The housing 110 may be configured to receive the motor can 206. The housing 110 and the motor can 206 may be configured to form coolant inlet passages 276 and coolant outlet passage 277. The housing 110 at the motor section 200 may include a first end ridge 115, middle ridges 116, and section ridge 117 extending radially inward that are configured to support the motor can 206. The coolant inlet passages 276 may be located radially outward from each end of the motor can 206 and may be radial passages configured to taper radially from the location of the coolant inlet lines 156 to the opposite circumferential side of the housing 110. One of the coolant inlet passages 276 may be formed by the first end ridge 115, a middle ridge 116, outer shell 120, and motor can 206. The other coolant inlet passage 276 may be formed by a middle ridge 116, section ridge 117, outer shell 120, and motor can 206.

The coolant outlet passage 277 may be located radially outward from motor can 206 and between the coolant inlet passages 276, and may be formed by the middle ridges 116, the outer shell 120 and the motor can 206. The coolant outlet passage 277 may also be configured to taper radially from the location of the coolant outlet line 157 to the opposite circumferential side of the housing 110.

The motor can 206 may include a body 201, an annular plate 204, motor cooling inlets 207, and a motor cooling outlet 208. The body 201 includes a hollow cylinder shape with a body first end 202 and a body second end 203, distal to the body first end 202. The body first end 202 may be located proximal first end 111 and first end cap 113. The body second end 203 may be the end of body 201 distal to first end 111 and first end cap 113. The annular plate 204 may be located at the body first end 202 and may extend radially inward from body 201. The bore defined by the annular shape of annular plate 204 may be sized and configured to receive all or a portion of first bearing 180.

Motor cooling inlets 207 may extend through body 201 adjacent opposite ends of body 201 and may be configured to supply coolant from a coolant inlet passage 276 to end windings 210 and stator laminations 220. Motor cooling inlets 207 may include multiple circumferential rows of radial holes at opposite ends of body 201. Motor cooling inlets 207 may be located axially on opposite sides of body 201 relative to motor cooling outlets 208. Motor cooling outlets 208 may extend through body 201 and may be a row of holes or slots located between the sets of motor cooling inlets 207 adjacent each end of body 201. Motor cooling outlet 208 may be arranged in a circumferential pattern and may be centrally located relative to body 201.

End windings 210 may be located within the motor can 206 at opposite ends of body 201. End windings 210 may be axially spaced apart. Lamination sleeve 228 may be centrally located within motor can 206 and may be axially located between the axial locations of end windings 210 relative to center axis 95. Lamination sleeve 228 may be radially inward from motor can 206 and contiguous to motor can 206. Lamination sleeve 228 may also be fixed to motor can 206. Lamination sleeve 228 may be a hollow cylinder shape. Lamination sleeve 228 may include lamination sleeve cooling outlets 229 extending through the hollow cylinder shape of lamination sleeve 228. Lamination sleeve cooling outlets 229 align with motor cooling outlet 208. Lamination sleeve cooling outlets 229 may be arranged in a circumferential pattern.

Stator laminations 220 may also be located axially between the end windings 210 located at opposite ends of body 201, may be located within lamination sleeve 228. Stator laminations 220 may be attached to lamination sleeve 228. Stator laminations 220 include a first lamination section 221 and a second lamination section 222 axially spaced apart with an air gap cooling outlet 226 located there between. First lamination section 221 and second lamination section 222 may be symmetrically oriented within the lamination sleeve 228. Air gap cooling outlet 226 is aligned with lamination sleeve cooling outlets 229. Air gap cooling outlets 226 may be axially aligned with lamination sleeve cooling outlets 229 and motor cooling outlets 208. First lamination section 221 may be radially spaced apart from driver shaft 230 forming a first air gap 224 there between and second lamination section 222 may be radially spaced apart from driver shaft 230 forming a second air gap 225 there between.

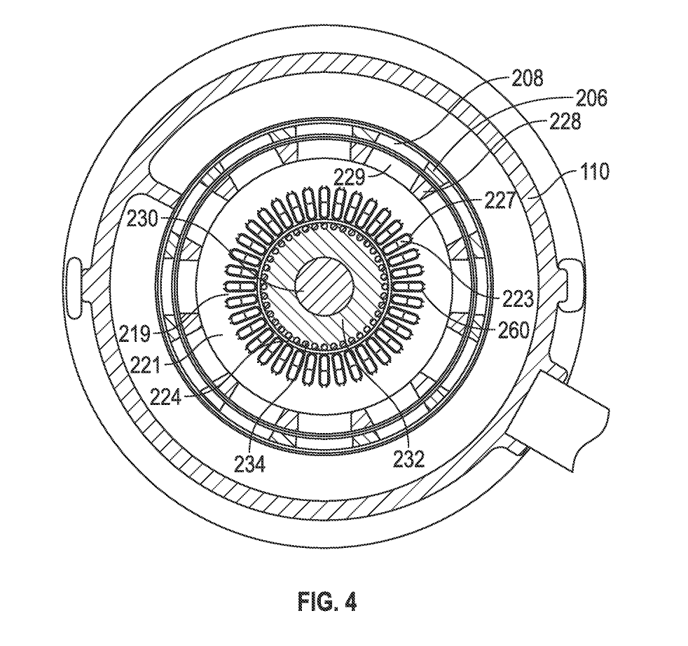

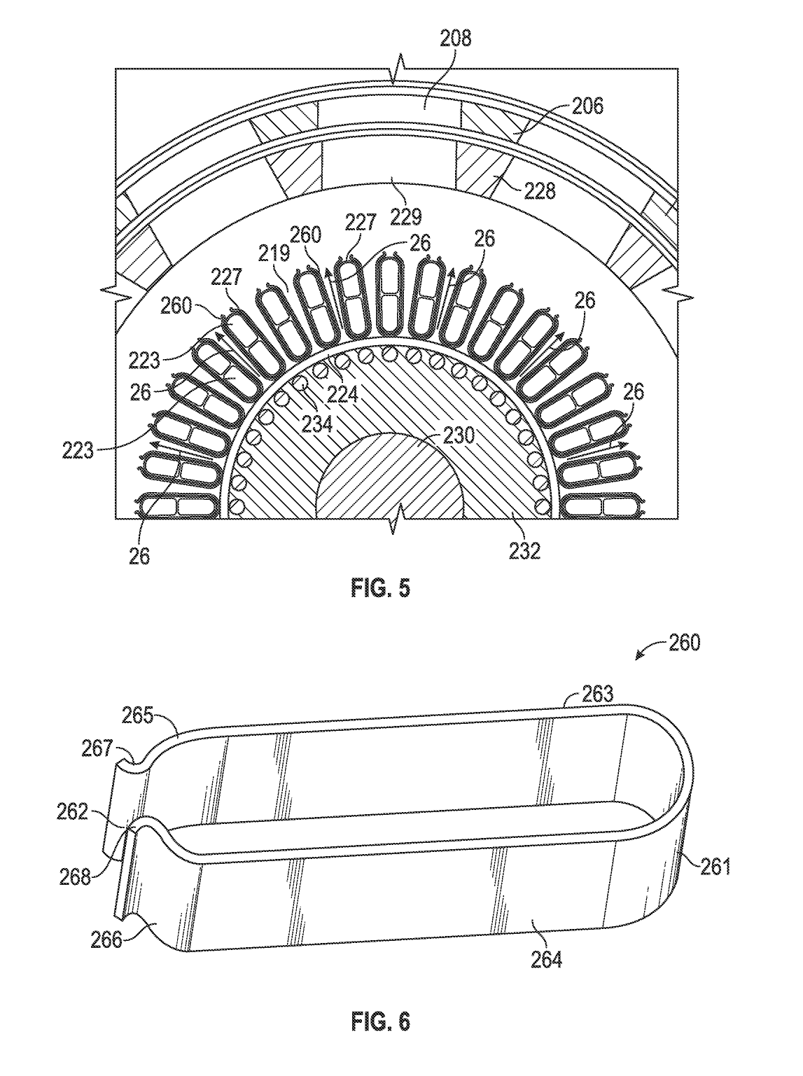

Motor windings 223 extend between end windings 210, through stator laminations 220, and across air gap cooling outlet 226. FIG. 4 is a cross-sectional view of the integrated machine 100 of FIG. 2 taken along the line IV-IV. FIG. 5 is a detailed view of the cross-section of FIG. 4. Referring to FIGS. 4 and 5, motor windings 223 may be arranged in circumferential groups with a cover 227 around each group when extending between first lamination section 221 and second lamination section 222. The cover 227 may be a thin layer of material, such as fish paper. A winding shield 260 may be located around each circumferential group over each cover 227. The groups may be arranged in a circumferential pattern. Air gap cooling outlet 226 includes circumferential gaps 219 between winding shields 260 of the circumferentially spaced groups.

All or a selection of the motor assembly 205 including the stator laminations 220, motor windings 223, covers 227, and winding shields 260 may be coated with a coating material that is tough and resistant to moisture and contamination, such as epoxy resin. The coating material may further protect the various components of the motor assembly 205. The coating material may be applied after the stator laminations 220, motor windings 223, covers 227, and winding shields 260 are all assembled together.

Winding shields 260 may be made of an insulating material. The insulating material may be a metal, such as aluminum. The insulating material may also be a non-conductive material, such as a non-ferrous metal. Winding shields 260 may be removable and may clip or latch around motor windings 223.

Driver shaft 230 may include bars 234 extending axially through shaft laminations 232. Bars 234 may be located near the outer surface of the shaft laminations 232. Bars 234 may be formed from a conductive material, such as copper.

FIG. 6 is a perspective view of a winding shield 260 of FIGS. 3 and 4. In the embodiment illustrated, winding shield 260 is a ‘C’ clip. Winding shield 260 may include first shield end 261, a second shield end 262, a first shield side 263, a second shield side 264, a first curved portion 265, and a second curved portion 266. First shield end 261 may be a curved panel, such as a ‘U’ shaped paned, and is a closed end. The first shield end 261 is configured to be wider than a group of motor windings 223 extending between the first lamination section 221 and the second lamination section 222, crossing the air gap cooling outlet 226 there between. Second shield end 262 may be an open end opposite first shield end 261.

First shield side 263 and second shield side 264 may be panels extending from first shield end 261 to second shield end 262 forming a space there between. First shield side 263 and second shield side 264 are configured to extend radially along a group of motor windings 223. First curved portion 265 may extend from first shield side 263 at second shield end 262.

First curved portion 265 may be a curved panel curving towards second shield side 264. Second curved portion 266 may extend from second shield side 264 at second shield end 262. Second curved portion 266 may be a curved panel curving towards first shield side 264 and first curved portion 265. First curved portion 265 and second curved portion 266 may be configured to curve partially around the radially outer end of a group of motor windings 223.

In the embodiment illustrated in FIGS. 3 and 4, winding shield 260 is configured to clip around cover 227 with first shield end 261 located adjacent driver shaft 230 and radially inward from second shield end 262. First curved portion 265 may include a first curved end 267 and second curved portion 266 may include a second curved end 268. The first curved end 267 and the second curved end 268 may curve away from each other. The convex surfaces of the first curved end 267 and the second curved end 268 may guide the open second shield end 262 around a cover 227 when installing winding shield 260 around the cover 227.

Winding shield 260 may include other configurations with a second shield end 262 that closes by latching or fastening first curved portion 265 and second curved portion 266 together.

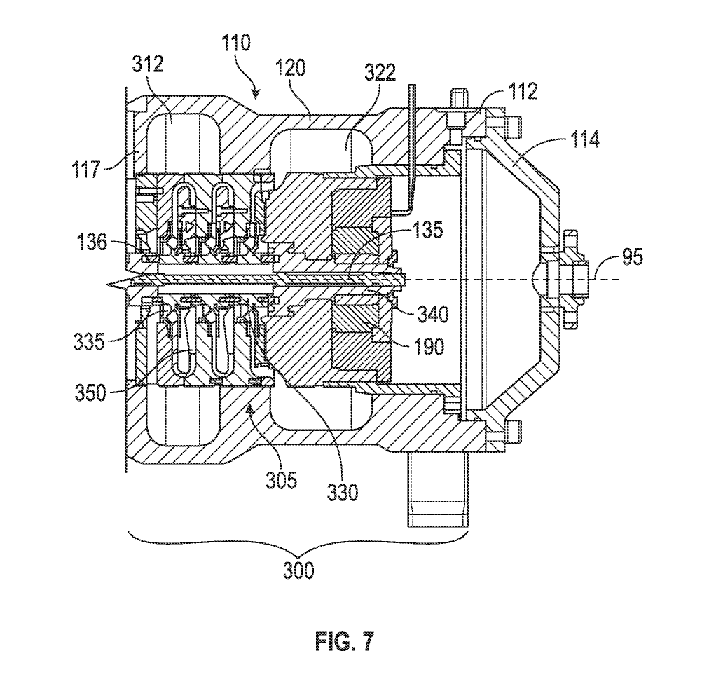

FIG. 7 is a detailed view of the cross-section of FIG. 2 at the rotary machine section 300. Referring FIGS. 2 and 7, rotary machine 305 as illustrated is a centrifugal gas compressor including an inlet passage 312, the machine rotor 330 that includes one or more centrifugal impellers 335, diffusers 350, and an outlet passage 322. The inlet passage 312 directs a process gas into the centrifugal gas compressor from the suction port 310 where the process gas is compressed. The process gas is then compressed by accelerating the process gas with centrifugal impellers 335 and converting the kinetic energy of the process gas to pressure in a diffuser 350 located downstream of each centrifugal impeller 335.

A centrifugal impeller 335 and its associated diffuser 350 may be considered a stage of the centrifugal gas compressor. In the embodiment illustrated, the centrifugal gas compressor includes 3 stages. After the process gas exits the diffuser 350 of the last stage, the outlet passage 322 directs the process gas to the discharge port 320. In embodiments, the machine rotor 330 includes the centrifugal impellers 335 and a stub shaft 340 connected to the centrifugal impellers 335.

### INDUSTRIAL APPLICABILITY

Rotary machines, such as centrifugal gas compressors, may be used in industry to accomplish various tasks, such as to move process gas from one location to another. For example, centrifugal gas compressors are often used in the oil and gas industries to move natural gas in a processing plant or in a pipeline. These rotary machines may be driven by electric motors for various reasons, such as when it is desirable to reduce onsite emissions.

Rotary machines may be provided with an electric motor in a single package as an integrated machine with the electric motor and the rotary machine within the same housing. Such an integrated machine may reduce the size of the overall package and may reduce the number of parts required for the package, resulting in cost and space savings.

During operation the electric motor may generate heat. Various components of the electric motor, such as the driver shaft 230 and the stator laminations 220, may require cooling. Referring to FIGS. 2-5, a symmetrical cooling scheme may be used. A coolant, such as air, may be directed into the integrated machine 100 from coolant inlet lines 156. The coolant may be circumferentially dispersed in the coolant inlet passages 276 located adjacent to each end of the motor can 206. The coolant is directed into the motor assembly 205 through motor cooling inlets 207 at each end of the motor can 206.

The coolant from one end of the motor can 206 is directed into the first air gap 224 along a first lamination cooling path 24 and towards the air gap cooling outlet 226. First lamination cooling path 24 is the axial path defined by the first air gap 224. The coolant from the other end of the motor can 206 is directed into the second air gap 225 along a second lamination cooling path 25 and towards the air gap cooling outlet 226. Second lamination cooling path is the axial path defined by the second air gap 224. The coolant travels along first lamination cooling path 24 and second lamination cooling path 25 and flows together into the air gap cooling outlet 226 and along cooling outlet path 26. Cooling outlet path 26 flows radially through circumferential gaps 219 of air gap cooling outlet 226 and between first lamination section 221 and second lamination section 222. This symmetrical cooling of the space between the driver shaft 230 and the stator laminations 220 by directing the coolant from each end of the motor assembly 205 and radially outward from the driver shaft 230 between the first lamination section 221 and the second lamination section 222 may improve cooling between the driver shaft 230 and the stator laminations 220 by reducing the amount of time the coolant is between the driver shaft 230 and the stator laminations 220. This symmetrical cooling scheme may also allow for a higher volume of coolant to be used.

Directing the coolant between the first lamination and the second lamination 222 in the symmetric cooling configuration may expose a portion of the motor windings 223 to the coolant. Without protection from the coolant, the heat of the coolant along with any contamination in the coolant may damage the motor windings 223 where the motor windings 223 extend between the first lamination section 221 and the second lamination section 222. Covers 227, such as fish paper, may protect the motor windings 223 from exposure to the coolant. However, the covers 227 may also be damaged and may erode from exposure to the heated/contaminated coolant. The winding shields 260 may further protect motor windings from the coolant by acting as heat shields and impact shields, and may protect the covers 227 and motor windings 223 from damage, such as erosion.

After passing between the winding shields 260 along cooling outlet path 26 and out of air gap cooling outlet 226, the coolant exits the motor can 206 through motor cooling outlets 208 and is collected in coolant outlet passage 277 where the coolant is directed into coolant outlet line 157.

The preceding detailed description is merely exemplary in nature and is not intended to limit the invention or the application and uses of the invention. The described embodiments are not limited to use in conjunction with a particular type of machine. Hence, although the present embodiments are, for convenience of explanation, depicted and described as being implemented in an integrated machine, it will be appreciated that the symmetrical cooling scheme including the configuration of the laminations, the air gap cooling outlet, and the winding shields can be implemented in various other types of electric motors, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. An electric motor for a rotary machine, the electric motor comprising:
a motor can including a body, motor cooling inlets extending through the body adjacent opposite ends of the body, and motor cooling outlets extending through the body;
a driver shaft extending through the motor can;
end windings within the motor can located at each of the opposite ends of the motor can and about the driver shaft;
a lamination sleeve centrally located within the motor can, the lamination sleeve including a hollow cylinder shape and lamination sleeve cooling outlets extending through the hollow cylinder shape, the lamination sleeve cooling outlets aligned with the motor cooling outlets;
stator laminations located within the lamination sleeve, the stator laminations including
a first lamination section radially spaced apart from the driver shaft forming a first air gap, and
a second lamination section radially spaced apart from the driver shaft forming a second air gap and axially spaced apart from the first lamination section forming an air gap cooling outlet there between, the air gap cooling outlet being in flow communication with the first air gap, the second air gap, and the lamination sleeve cooling outlets;
motor windings extending through the stator laminations and across the air gap cooling outlet, the motor windings being arranged in circumferential groups across the air gap cooling outlet forming circumferential gaps there between; and
a plurality of winding shields, each winding shield being located around one of the circumferential groups of the motor windings.

2. The electric motor of claim 1, wherein each winding shield is removable.

3. The electric motor of claim 2, wherein each winding shield is a clip and includes a first closed end, a second open end, a first side extending from the first closed end to the second open end, and a second side extending from the first closed end to the second open end.

4. The electric motor of claim 3, wherein each winding shield of the plurality of winding shields further includes a first curved portion extending from the first side towards the second side, and a second curved portion extending from the second side towards the first side.

5. The electric motor of claim 1, wherein each winding shield of the plurality of winding shields is formed of metal.

6. An integrated machine including the electric motor of claim 1 and the rotary machine within a single housing, the single housing being configured to form coolant inlet passages between the housing and the motor can, the coolant inlet passages being in flow communication with the motor cooling inlets, and a coolant outlet passage between the housing and the motor can, the coolant outlet passage being in flow communication with the motor cooling outlet.

7. The integrated machine of claim 6, wherein the rotary machine is a gas compressor.

8. An electric motor for a rotary machine, the electric motor comprising:
a motor can including a body with a center axis, motor cooling outlets extending radially through the body in a circumferential pattern, the motor cooling outlets being centrally located axially relative to the body, and motor cooling inlets extending radially through the body in circumferential patterns located axially on opposite sides of the body relative to the motor cooling outlets;
a driver shaft extending along the center axis;
end windings within the motor can about the driver shaft and axially spaced apart;
a lamination sleeve located within the motor can and axially between the axial locations of the axially spaced apart end windings, the lamination sleeve including a hollow cylinder shape and lamination sleeve cooling outlets extending through a middle of the hollow cylinder shape in a circumferential pattern, the lamination sleeve cooling outlets aligned with the motor cooling outlets;
stator laminations located within the lamination sleeve, the stator laminations including a first lamination section radially spaced apart from the driver shaft forming a first air gap and a second lamination section radially spaced apart from the driver shaft forming a second air gap, the first lamination section and the second lamination section being symmetrically oriented within the lamination sleeve and axially spaced apart forming an air gap cooling outlet there between, the air gap cooling outlet being axially aligned with the lamination sleeve cooling outlets; and
motor windings extending through the stator laminations and across the air gap cooling outlet, the motor windings being arranged in circumferential groups across the air gap cooling outlet forming circumferential gaps there between.

9. The electric motor of claim 8, further comprising:
a plurality of winding shields, each winding shield of the plurality of winding shields being located around one of the circumferential groups of the motor windings.

10. The electric motor of claim 9, wherein each winding shield of the plurality of winding shields is a removable clip and includes a first closed end, a second open end, a first side extending from the first closed end to the second open end, and a second side extending from the first closed end to the second open end.

11. The electric motor of claim 10, wherein each winding shield of the plurality of winding shields of the plurality of winding shields further includes a first curved portion extending from the first side towards the second side, and a second curved portion extending from the second side towards the first side.

12. The electric motor of claim 11, wherein each winding shield of the plurality of winding shields is formed of metal.

13. The electric motor of claim 12, wherein the metal is an insulating material.

14. An integrated machine including the electric motor of claim 8 and the rotary machine within a single housing, the single housing being configured to form coolant inlet passages between the housing and the motor can, the coolant inlet passages being in flow communication with the motor cooling inlets, and a coolant outlet passage between the housing and the motor can, the coolant outlet passage being in flow communication with the motor cooling outlet.

15. The integrated machine of claim 14, wherein the rotary machine is a gas compressor.

16. A winding shield for insulating and protecting motor windings of an electric motor, the winding shield comprising:
a first shield end including a ‘u’ shaped panel, the ‘u’ shaped panel configured to be wider than a grouping of the motor windings crossing an air gap cooling outlet between a first lamination section and a second lamination section within the electric motor;
a second shield end distal to the first shield end;
a first shield side extending between the first shield end and the second shield end, the first shield side being configured to extend radially along the grouping of the motor windings;
a second shield side extending between the first shield end and the second shield end, the second shield side being configured to extend radially along the grouping of the motor windings on an opposite side of the motor windings relative to the first shield side;
a first curved portion extending from the first shield side towards the second shield side, the first curved portion configured to curve partially around a radially outer end of the grouping of the motor windings; and
a second curved portion extending from the second shield side towards the first shield side, the second curved portion configured to curve partially around the radially outer end of the grouping of the motor windings.

17. The winding shield of claim 16, further comprising:
a first curved end extending from the first curved portion; and
a second curved end extending from the second curved portion;
wherein the first curved end and the second curved end curve away from each other and are configured to guide the first curved portion and the second curved portion around the grouping of the motor windings.

18. The winding shield of claim 17, wherein the winding shield is formed of aluminum.

19. The winding shield of claim 17, wherein the winding shield is an insulating material.

20. An electric motor including the winding shield of claim 16.
